(19) United States
(12) Patent Application Publication
(10) Pub. No.: US 2024/0425706 A1
(43) Pub. Date: Dec. 26, 2024

(54) FILM-FORMING COMPOSITION FOR METAL SURFACE, APPLICATION METHOD, POLYMER FILM, PIPE COMPRISING SUCH A FILM AND USE OF SUCH A FILM AGAINST HYDROGEN EMBRITTLEMENT

(71) Applicant: GRTGAZ, Bois Colombes (FR)

(72) Inventors: Monica ARNAUTU, Bois Colombes (FR); Charlotte DRAPPIER, Bois Colombes (FR); Laurent CLISSON, Bois Colombes (FR); Gil VILACA, Bois Colombes (FR)

(21) Appl. No.: 18/687,848

(22) PCT Filed: Aug. 29, 2022
(86) PCT No.: PCT/EP2022/073886

§ 371 Date: Feb. 29, 2024

(30) Foreign Application Priority Data
Sep. 1, 2021 (FR) FR2109131

(51) Int. Cl. C09D 5/08; C08K 3/22; C09D 7/61; C09D 123/08; C09D 129/04

(52) U.S. Cl. CPC C09D 5/084; C09D 7/61; C09D 123/0846; C09D 129/04; C08K 2003/2227

(57) ABSTRACT

The present invention relates to a film-forming composition for a metal surface (10), which composition comprises at least one vinyl polymer and/or one vinyl copolymer that is water-soluble, an aqueous solvent and solid alumina (Al₂O₃) particles dispersed in the aqueous solvent, the respective proportions of the composition are, relative to the total weight of the composition:
vinyl polymer and/or a vinyl copolymer: 5 to 25% by weight,
Al₂O₃: 0.2 to 10% by weight, and
aqueous solvent: 70 to 95% by weight.

The present invention also relates to a method for applying the composition, a film (20) obtained by the method, a pipe having this film and the use of such a film for protecting a metal surface against hydrogen embrittlement.

### TECHNICAL FIELD OF THE INVENTION

The present invention relates to a film-forming composition for a metal surface, a method for applying such a composition, a polymer film obtained by applying such a composition, and a pipe having this film.

The invention applies especially to the gas production and transportation industry, and in particular to the protection of the inner surface of a pipe made of steel which transports gaseous hydrogen.

### STATE OF THE ART

The physico-chemical properties of hydrogen, especially its very small size, cause gaseous hydrogen to be adsorbed on metal surfaces, such as steel, and then the hydrogen to migrate through the metal structure. This mechanism results in an irreversible accelerated ageing of the metal structure. This phenomenon is called hydrogen embrittlement (acronym “HE”). HE occurs in pipes, for example made of steel, which transport gaseous hydrogen.

Existing solutions mentioned in the prior state of the art consist of protecting the steel against HE by using an inorganic matrix type of coating, such as titanium carbide or titanium nitride. However, this type of coating is difficult to apply in existing pipes. For example, before applying the coating it is necessary to control the atmosphere or create a vacuum. In addition, sensitive products that are difficult to handle also have to be used for applying the coating on the surface to be protected. When these coatings have been applied on the metal surface, these coatings have the major drawback of being mechanically fragile. In addition, the existence of imperfections or cracks right from the application of the coating or generated afterwards, during the use of the pipe, compromises the protective effect of the coating.

Other solutions are taught in the prior state of the art and applied to the protection of a pipe transporting liquid solutions. However, they cannot be transposed to pipes transporting a gas. In addition, some hydrogen inhibitor compounds present in such a coating compromise the purity of the gaseous hydrogen transported.

Other solutions known to the person skilled in the art consist of using an oxide layer type of coating on the metal surface. This solution for coating a metal surface is known, and is used especially during steps for passivating metals, corresponding to a treatment making it possible to form an anti-corrosion oxide layer. However, this coating is not stable since it can be reduced by the gaseous hydrogen transported in the pipe.

Patent applications EP 30 06 522, CN 107 312 404, EP 31 78 897, JP 408 067 786, CN 105 860 696 and US 2016 319 176 are known, which disclose a composition making it possible to obtain a polymer film that can comprise PVA (PolyVinyl Alcohol) and alumina (Al₂O₃). However, such a composition generating such a film does not make it possible to effectively limit the HE, in particular by inhibiting hydrogen on the metal surface, the hydrogen circulating in a pipe for transporting gas.

### DESCRIPTION OF THE INVENTION

The present invention aims to remedy all or part of these drawbacks.

To this end, according to a first aspect, the present invention envisions a film-forming composition for a metal surface, which composition comprises at least one vinyl polymer and/or one vinyl copolymer that is water-soluble, an aqueous solvent and solid alumina (Al₂O₃) particles dispersed in the aqueous solvent.

Thanks to these provisions, the film-forming composition that is the subject of the invention can be applied on a metal surface and thus form a protective film against the mechanical embrittlement induced by a gas.

In some embodiments, the composition has respective proportions, relative to the total weight of the composition:
vinyl polymer and/or a vinyl copolymer: 5 to 25% by weight;
Al₂O₃: 0.2 to 10% by weight; and
aqueous solvent: 70 to 95% by weight.

Thanks to these provisions, the composition has better solubilisation of the polymers and a better uniform dispersion of solid alumina (Al₂O₃) particles, and thereby makes it possible to improve the barrier properties of the film obtained after applying the composition on the metal surface. In addition, the size of the solid alumina particles in such a composition and the viscosity conferred by the polymer makes it possible to keep the particles in suspension in the composition. Therefore the deposition and agglomeration of solid alumina particles in the composition are limited.

In some embodiments, the composition comprises at least one hydrogen adsorption, absorption and/or diffusion inhibitor.

Thanks to these provisions, when the composition is applied in a film on the metal surface, the hydrogen adsorption, absorption and/or diffusion inhibitor improves the protection of this surface against the mechanical embrittlement by hydrogen. For example, this protection is obtained during the circulation of hydrogen in a pipe made of steel that has this film.

In some embodiments, the hydrogen adsorption, absorption and/or diffusion inhibitor proportion is between 0.005% and 2%, relative to the total weight of the composition.

Thanks to these provisions, when the composition is applied in a film on the metal surface, the hydrogen adsorption, absorption and/or diffusion inhibitor provides optimum protection of this surface against hydrogen embrittlement.

In some embodiments, the composition comprises at least one vinyl copolymer, which is an ethylene vinyl-alcohol (acronym “EVOH”) copolymer.

Thanks to these provisions, when the composition is applied in a film on the metal surface, the presence of the EVOH copolymer improves the barrier properties of this film to different molecules, for example gases such as air, hydrogen, oxygen, carbon dioxide, methane or water.

According to a second aspect, the present invention envisions a method for applying the composition that is the subject of the present invention on a metal surface, which method comprises:
at least one step of spraying the composition onto the surface; and
at least one step of drying and/or curing of the sprayed composition.

Thanks to these provisions, the large-scale application of the film-forming composition is implemented, in particular onto a large metal surface such as the inner surface of a pipe transporting a gas such as hydrogen. This method also makes it possible to form a film that is homogeneous, continuous and mechanically stable.

In some embodiments, the method comprises at least two iterations of the spraying step and the drying and/or curing step.

Thanks to these provisions, a film with several successive layers is formed, whose thickness thus improves the barrier against a gas, such as hydrogen, by optimising the drying time. The thicker the film, the greater the barrier effect.

According to a third aspect, the present invention envisions a polymer film obtained by applying a composition that is the subject of the present invention, which comprises at least one vinyl polymer and/or one vinyl copolymer and dispersed solid alumina (Al₂O₃) particles.

In some embodiments, the proportions, relative to the total weight of the film, are:
vinyl polymer and/or a vinyl copolymer: 70 to 95% by weight; and
Al₂O₃: 3.5 to 30% by weight.

Thanks to these provisions, a metal surface is protected against the embrittlement induced by a gas. For example, the steel is protected against hydrogen embrittlement by limiting the penetration of hydrogen into the surface of the steel.

In some embodiments, the polymer film comprises a hydrogen adsorption, absorption and/or diffusion inhibitor, the proportions of the constituents of the film being, relative to the total weight of the:
vinyl polymer and/or a vinyl copolymer: 70 to 95% by weight;
Al₂O₃: 3.5 to 30% by weight; and
hydrogen adsorption, absorption and/or diffusion inhibitor: 0.05 to 6% by weight.

In some embodiments, the polymer film also comprises a hydrogen adsorption, absorption and/or diffusion inhibitor.

In some embodiments, the proportions, relative to the total weight of the film, are:
vinyl polymer and/or a vinyl copolymer: 70 to 95% by weight;
Al₂O₃: 3.5 to 30% by weight; and
hydrogen adsorption, absorption and/or diffusion inhibitor: 0.05 to 6% by weight.

Thanks to these provisions, the hydrogen adsorption, absorption and/or diffusion inhibitor incorporated to the film that is the subject of the present invention improves the protection of the metal surface against hydrogen embrittlement. For example, this protection is obtained during the circulation of hydrogen in a pipe made of steel coated with this film.

In some embodiments, the film comprises at least one vinyl copolymer, which is an ethylene vinyl-alcohol (EVOH) copolymer.

Thanks to these provisions, the presence of the EVOH copolymer improves the barrier properties to different gases such as air, hydrogen, oxygen, carbon dioxide, methane or water.

In some embodiments, the film has a thickness, after drying, of between 50 micrometres and 1 millimetre.

Thanks to these provisions, the thickness provides the film with improved barrier properties against different gases.

In some embodiments, the Al₂O₃ particles form loads having a shape factor of between 10 and 1000.

According to a fourth aspect, the present invention envisions a pipe that comprises a polymer film that is the subject of the invention.

As the particular aims, advantages and features of the pipe that is the subject of the present invention are similar to those of the film that is the subject of the present invention, they are not repeated here.

According to a fifth aspect, the present invention envisions the use of a polymer film that is the subject of the present invention for protecting a metal surface against hydrogen embrittlement.

As the particular aims, advantages and features of the use that is the subject of the present invention are similar to those of the film that is the subject of the present invention, they are not repeated here.

### BRIEF DESCRIPTION OF THE FIGURES

Other advantages, aims and particular features of the invention will become apparent from the non-limiting description that follows of at least one particular embodiment of the composition, method, film and pipe that are the subjects of the present invention, with reference to drawings included in an appendix, wherein:

FIG. 1 represents, schematically, the penetration of hydrogen into the metal structure, responsible for hydrogen embrittlement;

FIG. 2 represents, schematically, the effect of an embodiment of a polymer film that is the subject of the present invention on the penetration of hydrogen;

FIG. 3 represents, schematically, the effect of an embodiment of a polymer film that is the subject of the present invention on the penetration of hydrogen;

FIG. 4 represents, schematically, a tortuosity effect linked to the presence of solid alumina (Al₂O₃) particles in the polymer film;

FIG. 5 represents, schematically, a tortuosity effect linked to the presence of solid alumina (Al₂O₃) particles in the polymer film;

FIG. 6 represents, in the form of a logical diagram, a particular embodiment of the method that is the subject of the present invention; and

FIG. 7 represents, schematically, a particular embodiment of a device for applying the film-forming composition and a pipe that is the subject of the present invention.

### DESCRIPTION OF THE EMBODIMENTS

The present description is given in a non-limiting way, in which each characteristic of an embodiment can be combined with any other characteristic of any other embodiment in an advantageous way.

The following definitions are noted here:
the term “film-forming” refers to a composition forming a film, for example after drying and/or curing;
the term “metal surface” refers to any type of surface comprising a metal, for example an alloy such as steel;
the term “aqueous solvent” refers to a solvent comprising at least fifty percent water;
the term “hydrogen adsorption, absorption and/or diffusion inhibitor” refers to a compound limiting the propagation and/or the adsorption or absorption of hydrogen at the location of the metal surface and/or in the metal structure when it is applied on the surface of the metal,
the term “loads” refers to solid particles.
   Note that the figures are not to scale.

### Film-Forming Composition

The film-forming composition that is the subject of the present invention comprises at least one vinyl polymer and/or one vinyl copolymer that is water-soluble, an aqueous solvent and solid alumina (Al₂O₃) particles dispersed in the aqueous solvent.

This film-forming composition can be applied on any type of surface, for example a metal surface 10, and results in the formation of a film 20.

Preferably, the solid alumina particles are dispersed homogeneously in the composition.

The use of an aqueous solvent in the composition enables good solubilisation of the polymers, and a good uniform dispersion of solid alumina (Al₂O₃) particles in the composition. When the particles are exfoliated, an improvement in the barrier properties of the polymer film 20 formed from the film-forming composition can be observed. Organic solvents such as dimethyl sulphoxide or cyclohexanone do not make such a uniform dispersion of the solid alumina (Al₂O₃) particles possible.

Preferably, the aqueous solvent is distilled water.

Preferably, the composition comprises at least one vinyl copolymer, which is an ethylene vinyl-alcohol (EVOH) copolymer.

Preferably, the composition has respective proportions, relative to the total weight of the composition, of:
vinyl polymer and/or a vinyl copolymer: 5 to 25% by weight;
Al₂O₃: 0.2 to 10% by weight; and
aqueous solvent: 70 to 95% by weight.

Thanks to these provisions, the composition has an optimum exfoliation of solid alumina (Al₂O₃) particles, thus making it possible to improve the barrier properties of the film 20 obtained after applying the composition on the metal surface 10. Such a polymer concentration provides the composition with sufficient viscosity to facilitate the application, for example by a device and according to a method 30 that is the subject of the present invention. The viscosity of the composition is between 30 and 7500 mPa·s, and is therefore suitable for forming the film 20 with a thickness of between 50 micrometres and 1 millimetre.

Even more preferably, the composition has respective proportions, relative to the total weight of the composition, of:
vinyl polymer and/or vinyl copolymer: 5 to 20% by weight;
Al₂O₃: 0.5 to 5% by weight; and
aqueous solvent: 75 to 90% by weight.

In some embodiments, the composition that is the subject of the present invention also comprises at least one hydrogen adsorption, absorption and/or diffusion inhibitor.

Thanks to these provisions, the adsorption, absorption and/or diffusion inhibitor incorporated into the film 20 and coming from the composition that is the subject of the present invention has better barrier properties against hydrogen, and thus prevents the hydrogen embrittlement of a metal structure.

The hydrogen adsorption, absorption and/or diffusion inhibitor respectively limits the dissociative adsorption of gaseous hydrogen at the surface of the metal, and the penetration of hydrogen into the metal surface 10. For example, this protection is obtained during the circulation of hydrogen in a pipe made of steel that has this film 20.

The hydrogen adsorption, absorption and/or diffusion inhibitor can be chosen from amongst the following chemical families:
nitriles, benzonitriles;
alcohols;
alkenes;
alkynes;
conjugated cyclic and heterocyclic compounds;
cyanamides;
acids;
isocyanates;
cyanonaphthalene;
amines and other nitrogen compounds;
salts of nitrogen compounds;
carbides;
nitrides; and/or
any mixture or solution containing one or more of the above compounds.

It is noted that such inhibitors are, in particular, able to be adsorbed at the surface of a metal substrate, such as a metal surface, in order to control the electrochemical reactivity of such a substrate. Therefore, the inhibitors are compounds known as “interfacially active”. In particular, the inhibitors cover the metal surface, for example a surface made of iron, by electrostatic interactions. For example, the inhibitors have at least one active centre able to interact with the electronic layer of the metal, for example nitrogen or oxygen.

The hydrogen inhibition function of such inhibitors is obtained using, for example, at least one of the following two modes of action:
a mechanism, referred to as “physisorption”, corresponding to an adsorption of the inhibitor on the metal surface, blocking cathodic active sites for electron transfer from the metal, preventing the discharge of hydrogen on the metal, and therefore limiting the reaction responsible for penetration in the metal substrate;
a mechanism, referred to as “chemisorption”, corresponding to capturing uncharged hydrogen ions at the surface of a metal, such a capture being carried out by a layer of inhibitor molecules, such an inhibitor reacting with a proton (H⁺).

Preferably, the hydrogen adsorption, absorption and/or diffusion inhibitor proportion is between 0.005% and 2% by weight, relative to the total weight of the composition.

For example, the hydrogen adsorption, absorption and/or diffusion inhibitor proportion is between 0.03% and 0.07% by weight, relative to the total weight of the composition. These values correspond to a compromise between the adhesion and performance levels of the film 20. If the hydrogen adsorption, absorption and/or diffusion inhibitor proportion is greater than 0.07% by weight, relative to the total weight of the composition, the adhesion of the film declines. If the hydrogen adsorption, absorption and/or diffusion inhibitor proportion is less than 0.03% by weight, relative to the total weight of the composition, efficiency is reduced.

In some embodiments, the composition is prepared by mixing two intermediate compositions, for example one composition comprising solid alumina particles and the other composition comprising at least one vinyl polymer and/or one vinyl copolymer.

Preferably, the two intermediate compositions are prepared at the same time.

In other embodiments, the two compositions are prepared in succession. For example, the composition comprising solid alumina particles is obtained by adding a predefined quantity of alumina to water, followed by agitation at ambient temperature. Next, the composition comprising a polymer is obtained by adding a predefined quantity of solid polymer to water, followed by agitation. The composition that is the subject of the present invention is obtained by mixing predefined quantities of these two compositions, followed by agitation at ambient temperature.

Preferably, the agitation of the compositions is implemented by an industrial agitator, for example a mechanical agitator. Thanks to these provisions, the preparation of the composition that is the subject of the present invention is possible on an industrial scale.

In some embodiments, the composition comprising the solid alumina particles is subjected to ultrasounds.

In some embodiments, the composition comprising the polymer is heated to 90° C. then cooled to ambient temperature.

Thanks to these provisions, the solubilisation of the polymer in the composition is optimum.

In some embodiments, the composition also comprises a gelling agent configured such that the composition forms a gel. Preferably, the gelling agent proportion is between 0.01% and 5% by weight, and preferably between 1% and 2% by weight, relative to the total weight of the composition. The viscosity of the composition is therefore increased.

### Example of Realisation of the Composition

All the percentages presented below are percentages by weight (m/m).

An example of preparation of the composition referred to as “composition C” is described below.

Two intermediate compositions, called “intermediate compositions A and B”, are prepared and then mixed to obtain “composition C”, corresponding to an embodiment of the subject of the invention.

Intermediate composition A corresponds to a dispersion of alumina (Al₂O₃) of 24% m/m in distilled water. Composition A is obtained by adding 12 grammes of alumina (Al₂O₃) into 38 grammes of distilled water, followed by agitation with a bar magnet for 30 minutes at ambient temperature and exposure to ultrasounds for an additional 30 minutes through the use of an ultrasound bath.

Intermediate composition B corresponds to a composition with 10% EVOH copolymer in distilled water. It is obtained by adding 10 grammes of EVOH copolymer, for example Exceval 2117 (registered trademark), into 90 grammes of distilled water, followed by agitation with a bar magnet with heating to 90° C. until the complete solubilisation of the copolymer.

Composition C is then obtained by mixing 25 grammes of composition B, 0.7 grammes of composition A and 0.0135 grammes of hydrogen adsorption, absorption and/or diffusion inhibitor, for example SurTec 424 (registered trademark), followed by agitation with a bar magnet at ambient temperature for 30 minutes.

### Polymer Film

The polymer film 20 that is the subject of the present invention is obtained from an embodiment of the composition that is the subject of the present invention described above.

Preferably, the polymer film 20 is obtained according to an embodiment of the method that is the subject of the present invention described below.

Preferably, the proportions, relative to the total weight of the film, are:
vinyl polymer and/or a vinyl copolymer: 70 to 95% by weight; and
Al₂O₃: 3.5 to 30% by weight.

Given the composition from which the film is derived, the film 20 has a polymer matrix composite in which the alumina particles are uniformly dispersed.

The film 20 is applied as a coating of a metal surface 10 and makes it possible, thanks to its barrier properties, to protect this surface against the mechanical embrittlement induced by a gas. For example, this film 20 protects steel against hydrogen embrittlement by limiting the contact between the hydrogen and the surface of the steel.

The barrier properties of this film 20 for coating a metal surface 10 make it possible to:
slow down the diffusion of a gas, such as gaseous hydrogen, to the metal surface 10; and
locally reduce the concentration of a gas, such as gaseous hydrogen, on the metal surface 10.

As a result, the permeability of the gas in the polymer film 20 and the penetration of the gas into the metal surface 10 are significantly reduced. For example, the permeability is reduced by a factor of two, three or four.

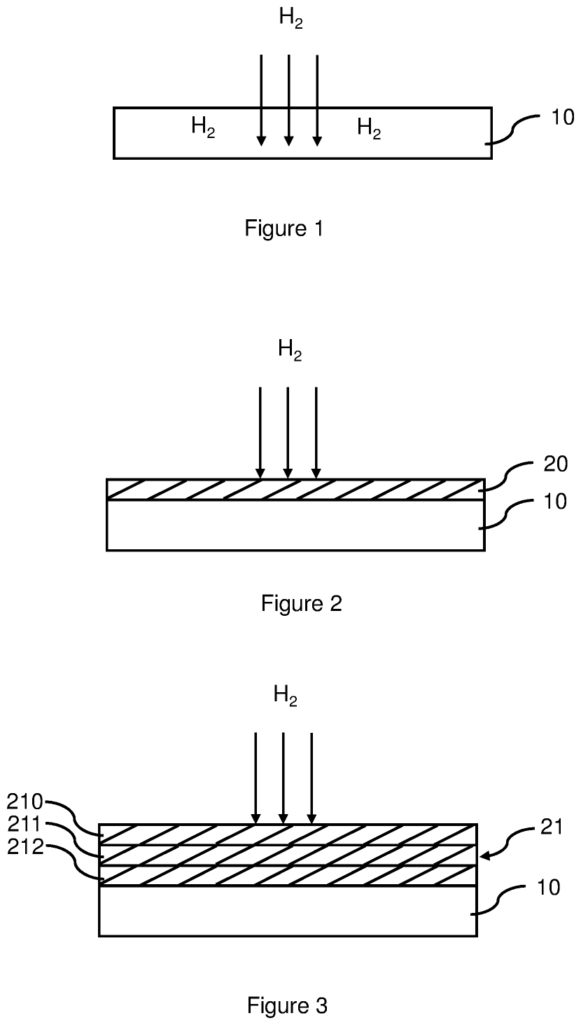

FIG. 1, which is not to scale, shows a schematic representation of a metal surface 10 in which the hydrogen penetrates and diffuses in the metal surface 10. The metal surface 10 has no polymer film that is the subject of the present invention.

FIGS. 2 and 3, which are not to scale, show the barrier properties of the polymer film, 20 or 21, used as coating for the metal structure 10. FIGS. 2 and 3, unlike FIG. 1, show that the polymer film, 20 or 21, limits the penetration of hydrogen into the metal surface 10.

The presence of at least one vinyl polymer and/or one vinyl copolymer forming the film provides the film with its barrier properties to different gases such as air, hydrogen, oxygen, carbon dioxide, methane or water.

Preferably, the film 20 comprises at least one vinyl copolymer, which is an ethylene vinyl-alcohol (EVOH) copolymer.

The dispersed solid alumina (Al₂O₃) particles enable an improvement in the barrier properties of the film, in particular by increasing the tortuosity.

In some embodiments, as shown in FIG. 3, Ie film 21 comprises several successive layers, 210, 211 and 212, bound to each other. Each layer is obtained after applying and drying the composition that is the subject of the present invention. FIG. 3, which is not to scale, shows the barrier properties of the film used as coating for the metal structure 10 and formed of three successive layers, 210, 211 and 212. Preferably, each layer has a thickness of between 20 and 30 micrometres.

Thanks to these provisions, the barrier effect against a gas, such as hydrogen, is improved.

Preferably, the polymer film is a film of composite type made up of a polymer matrix and one or more load(s) formed by the alumina particles having a high shape factor, i.e. having one dimension much smaller than the other two, for example by a factor of 10 to 1000, thus enabling a tortuosity effect.

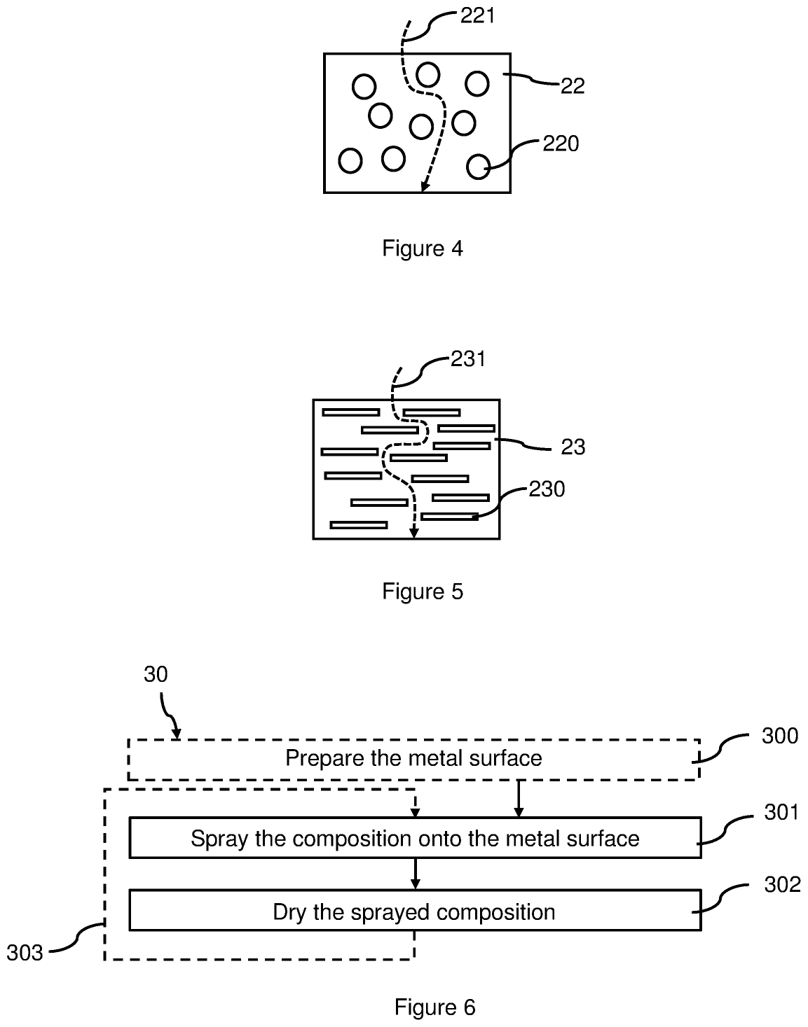

FIGS. 4 and 5, which are not to scale, show a schematic representation of two tortuosity effects applied to a gas within the films, 22 or 23, that are the subjects of the present invention. The paths of the gas, 221 or 231, making it possible to illustrate the tortuosity effect, are shown by dashed arrows.

The tortuosity effects correspond to a lengthening of the diffusion path of the diffused molecules, such as the constituent molecules of a gas, for example gaseous hydrogen. This lengthening results in a reduction in the coefficient of diffusion through the polymer film, and therefore a decrease in the permeability of the molecules diffusing through this film. Consequently, penetration of the diffusing molecules into the metal surface 10 is very limited.

In FIG. 4, the tortuosity effect illustrated by the path 221 is linked to the shape of the solid particles 220 dispersed in the film 22. The particles 220 have a substantially spherical shape. This effect is present, for example, in a polymer matrix composite.

In FIG. 5, the tortuosity effect illustrated by the path 231 is linked to the shape of the solid particles 230 dispersed in the film 23. This effect is present, for example, in a polymer matrix composite. The solid particles 230 have a substantially platelet shape. The path 231 created by the substantially platelet particles 230 and traversed by the diffusing molecules is longer than the path 221 created by the substantially spherical particles 220.

Consequently, the tortuosity within the film 23 is higher than the tortuosity within the film 22. The film 23 has better barrier properties compared to the film 22.

Preferably, the film that is the subject of the present invention comprises a structure similar to film 23, i.e. with substantially platelet solid particles.

In some embodiments, the polymer film comprises a hydrogen adsorption, absorption and/or diffusion inhibitor, the proportions of the constituents of the film being, relative to the total weight of the film:
vinyl polymer and/or a vinyl copolymer: 70 to 95% by weight;
Al₂O₃: 3.5 to 30% by weight; and
hydrogen adsorption, absorption and/or diffusion, adsorption and/or diffusion inhibitor: 0.05 to 6% by weight.

In some embodiments, the film has a thickness of between 50 micrometres and 1 millimetre, and preferably greater than 250 micrometres.

### Permeability Tests

Helium permeability tests were performed to identify the tortuosity effect of the solid alumina (Al₂O₃) particles in the polymer film obtained after applying the composition C described above to samples. The samples used were prepared by depositing a disk of porous fabric in a silicone mould in the shape of a disk with the same diameter as the disk of porous fabric. Next, 13 grammes of composition C, described above, were applied and impregnated uniformly in the fabric. Then, the fabric impregnated with composition C was dried during 72 hours at ambient temperature and 6 hours at 60° C. The following table shows the results of the permeability measurements for the polymer films made up of the EVOH copolymer with or without solid alumina (Al₂O₃) particles.

TABLE 1

| | Permeability coefficient |
|---|---|
| Nature of the film | P, g/(m · s · bar) |
| EVOH alone | 9.44 × 10⁻⁹ |
| EVOH + Al₂O₃ | 3.21 × 10⁻⁹ |

The permeability coefficient P is divided by three when the film made up of the EVOH copolymer comprises the solid alumina (Al₂O₃) particles, demonstrating the tortuosity effect of these particles and therefore a decrease in the permeability of the helium.

### Method for Applying the Composition

The present invention also envisions a method 30 for applying the film-forming composition on a metal surface that is the subject of the present invention, which comprises:
at least one step 301 of spraying the composition onto the surface; and
at least one step 302 of drying and/or curing the sprayed composition.

In some embodiments, when the composition forms a gel, the spraying step 301 is replaced by an application step. The application can be carried out by means of a paintbrush or a tank and a piston applicator. In other words, the gel is deposited by contact.

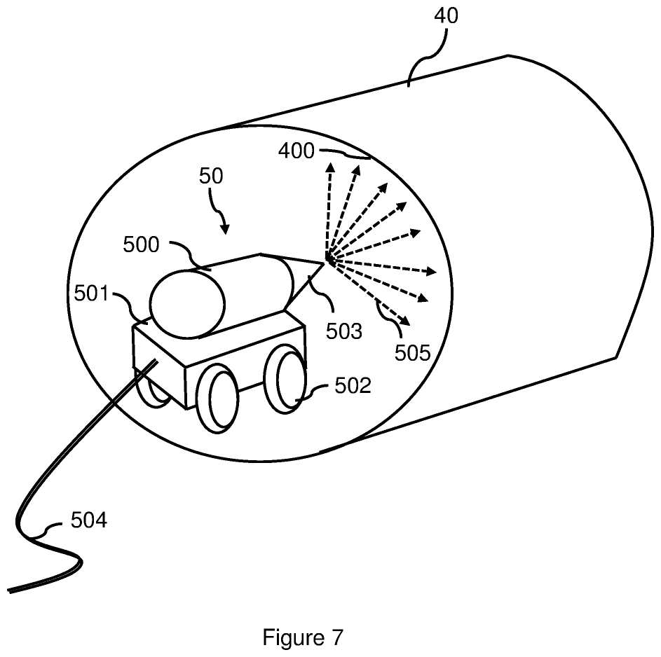

FIG. 6 shows a logical diagram representing a particular embodiment of the method that is the subject of the present invention. The optional steps are shown by dashed lines. The embodiments of the method 30 that is the subject of the present invention are illustrated with the device 50 and the pipe 40 shown in FIG. 7.

In some embodiments, the metal surface corresponds to the inner surface 400 of a pipe 40 used for transporting a gas. For example, the pipe 40 is a pipe for transporting and supplying natural gas, such as methane, into which gaseous hydrogen has been injected.

In some embodiments, the spraying step 301 is implemented by a spray device 50.

Thanks to these provisions, the step 301 of spraying the composition that is the subject of the present invention is carried out on the inner surface 400 of a pipe 40 previously installed. For example, the pipe 40 has a diameter of less than 1.2 metres and comprises elbow parts.

In some embodiments, such as that shown in FIG. 7, the spray device 50 comprises:
a means for movement;
a tank 500 for storing the composition that is the subject of the present invention to be sprayed; and
at least one spray head 503 connected to the tank 500 and transmitting the sprayed composition 505.

Preferably, the device 50 comprises a means for movement comprising a carriage 501 mounted on wheels 502. The carriage bears the tank 500. Even more preferably, the carriage 501 comprises a motor configured to activate at least one wheel 502 and cause the carriage 501 to move in the pipe 40.

In some embodiments (not shown), the carriage comprises pads. Preferably, the pads are arranged radially around the tank.

In some embodiments (not shown), the pads rest totally on, or on a portion of, the inner surface of the pipe.

In some embodiments, such as that shown in FIG. 7, the device 50 comprises an electrical power source. The electrical power source comprises a cable 504 connected to an electricity network. In some embodiments (not shown), the electrical power source is an autonomous electrical power source, for example a battery. The autonomous electrical power source is mounted on the carriage and supplies the motor with electrical energy. In some embodiments (not shown), the device is drawn manually inside the pipe 40.

Preferably, the composition is sprayed during the spraying step 301 by means of a spray head 503, having a truncated conical shape equipped with holes through which the composition is ejected. The spraying 505 of the composition is shown by the dashed arrows in FIG. 7. For example, the device 50 carries out the spraying step 301 in pipes that can have a length of at least 100 kilometres and a diameter of between 2.5 centimetres and 1.5 metres.

In some embodiments (not shown), the spray device comprises several spray heads.

In some embodiments (not shown), the spray head carries out the spraying step by rotation. For example, the speed of rotation is between 5 and 50 revolutions per minute. The spraying step 301 is therefore implemented by the centrifugal force linked to the rotational speed of the spray head.

In some embodiments, the spray head carries out the spraying step by ejecting a static mixture under pressure. For example, the spraying pressures are between 20 and 200 bar.

Thanks to these provisions, the device makes it possible to spray the composition that is the subject of the present invention over the entire inner surface 400 of a pipe 40 with a diameter of between 200 and 1200 millimetres.

In some embodiments (not shown), the spray device 50 comprises a camera connected to a terminal which comprises:
at least one screen to display the information provided by the camera; and
at least one human-machine interface, for example a keyboard and a mouse, configured to control the spray device 50.

Thanks to these provisions, the spraying step 301 is monitored and controlled remotely by an operator when the device 50 is used.

In some embodiments, the step 302 of drying and/or curing the sprayed composition is carried out by pulsation and/or by circulation of a flow of hot air. For example, one or more fans are installed in the pipe to make the flow of hot air circulate.

Thanks to these provisions, the drying and/or curing step is speeded up.

In some embodiments, the step of drying and/or curing the sprayed composition is carried out by the emission of infrared radiation from one or more lamps emitting infrared radiation.

In some embodiments, the method comprises at least two iterations 303 of the spraying step 301 and the drying and/or curing step 302. For example, the iterations 303 are performed by the circulation of two spray devices in the pipe carrying out the spraying step 301, the time interval between the passage of the two robots being configured such that the drying step 302 of the first iteration is carried out between the passage of the two robots.

In some embodiments, the method 30 comprises, before the spraying step 301, a step 300 of preparing the metal surface. For example, the preparation step 300 comprises a step of abrasive blast cleaning, these abrasives then being removed from the metal surface, for example, by means of a vacuum cleaner or a compressed air hose free of oils.

### Pipe Coated With the Polymer Film

The present invention also envisions a pipe that comprises a polymer film having the characteristics mentioned above. For example, the pipe 40 comprises a polymer film 20 obtained by applying a composition that is the subject of the present invention according to the method 30. These elements have been described, mutatis mutandis, with reference to FIGS. 2, 6 and 7.

1. Film-forming composition for a metal surface characterised in that it comprises at least one vinyl polymer and/or one vinyl copolymer that is water-soluble, an aqueous solvent and solid alumina (Al₂O₃) particles dispersed in the aqueous solvent.

2. Composition according to claim 1, wherein the respective proportions, relative to the total weight of the composition, are:
vinyl polymer and/or a vinyl copolymer: 5 to 25% by weight;
Al₂O₃: 0.2 to 10% by weight; and
aqueous solvent: 70 to 95% by weight.

3. Composition according to claim 3, which comprises at least one hydrogen adsorption, absorption and/or diffusion inhibitor.

4. Composition according to claim 3, wherein the hydrogen adsorption, absorption and/or diffusion inhibitor proportion is between 0.005% and 2%, relative to the total weight of the composition.

5. Composition according to claim 1, wherein at least one vinyl copolymer is an ethylene vinyl-alcohol (EVOH) copolymer.

6. Method for applying the composition according to claim 1, on a metal surface, characterised in that it comprises:
at least one step of spraying the composition onto the surface; and
at least one step of drying and/or curing the sprayed composition.

7. Method according to claim 6, which comprises at least two iterations of the spraying step and the drying and/or curing step.

8. Polymer film obtained by applying a composition according to claim 1, characterised in that it comprises at least one vinyl polymer and/or one vinyl copolymer and dispersed solid alumina (Al₂O₃) particles.

9. Polymer film according to claim 8, wherein the proportions, relative to the total weight of the film, are:
vinyl polymer and/or a vinyl copolymer: 70 to 95% by weight; and
Al₂O₃: 3.5 to 30% by weight.

10. Polymer film obtained by applying a composition according to claim 3, which also comprises at least one hydrogen adsorption, absorption and/or diffusion inhibitor.

11. Polymer film according to claim 10, wherein the proportions, relative to the total weight of the film, are:
vinyl polymer and/or a vinyl copolymer: 70 to 95% by weight;
Al₂O₃: 3.5 to 30% by weight; and
hydrogen adsorption, absorption and/or diffusion inhibitor: 0.05 to 6% by weight.

12. Polymer film according to claim 8, wherein at least one vinyl copolymer is an ethylene vinyl-alcohol (EVOH) copolymer.

13. Polymer film according to claim 8, which has a thickness, after drying, of between 50 micrometres and 1 millimetre.

14. Polymer film according to claim 8, wherein the Al₂O₃ particles form loads having a shape factor of between 10 and 1000.

15. Pipe that comprises a polymer film according to claim 8.

16. Use of a polymer film according to claim 8, for protecting a metal surface against hydrogen embrittlement.
